(19) United States
(12) Patent Application Publication
(10) Pub. No.: US 2015/0287361 A1
(43) Pub. Date: Oct. 8, 2015

(54) PIXEL AND PIXEL DRIVING METHOD

(71) Applicant: SAMSUNG DISPLAY CO., LTD., Yongin-City (KR)

(72) Inventors: Kwang Sae LEE, Cheonan-si (KR); Jeong Geun YOO, Yongin-si (KR); Min Ho CHUN, Cheonan-si (KR)

(21) Appl. No.: 14/480,785

(22) Filed: Sep. 9, 2014

(30) Foreign Application Priority Data
Apr. 8, 2014 (KR) 10-2014-0041825

(51) Int. Cl. G09G 3/32

(52) U.S. Cl. CPC G09G 3/3258; G09G 3/3241; G09G 2300/08; G09G 2320/0223; G09G 2300/0842; G09G 2300/0861; G09G 2300/0819

(57) ABSTRACT

A pixel includes a main circuit, a sub circuit, and an organic light emitting diode. Each of the main circuit and the sub circuit includes a switching transistor to switchably operate based on a first scan signal, a driving transistor to receive a data voltage through the switching transistor, and a storage capacitor to store the data voltage. The organic light emitting diode emits light based on current flowing through one of the main circuit or the sub circuit.

### CROSS-REFERENCE TO RELATED APPLICATION

Korean Patent Application No. 10-2014-0041825, filed on Apr. 8, 2014, and entitled, “Pixel and Pixel Driving Method,” is incorporated by reference herein in its entirety.

### BACKGROUND

1. Field

One or more embodiments herein relate to a pixel and a pixel driving method.

2. Description of the Related Art

A display device is used in a variety of portable information terminals (e.g., personal computers, mobile phones, personal digital assistants, etc.) and in a variety of monitors. Examples of the monitors include liquid crystal display panels, organic light emitting display panels, and plasma display panels. Among these, organic light emitting display panels have excellent light emission efficiency, luminance and viewing angle, and quick response speed.

Organic light emitting display panels have a display area which includes a plurality of pixels arranged on a substrate in matrix form. The pixels are connected to scan lines and data lines and emit light to form an image. The pixels emit light using organic light emitting diodes, which generate light having predetermined luminance based on data current.

When a defect is generated in a pixel circuit during the manufacturing process, a repair process may be performed by cutting the defective portion of the circuit and remanufacturing it. However, this technique may result in a low success rate of regeneration and a long tact time.

### SUMMARY

In accordance with one embodiment, a pixel includes a main circuit, a sub circuit, and an organic light emitting diode, wherein each of the main circuit and the sub circuit includes a switching transistor to switchably operate based on a first scan signal, a driving transistor to receive a data voltage through the switching transistor, and a storage capacitor to store the data voltage, and wherein the organic light emitting diode emits light based on current flowing through one of the main circuit or the sub circuit.

Each of the main circuit and the sub circuit may include an initialization transistor connected to a gate electrode of the driving transistor and a second voltage source line, the initialization transistor in each of the main circuit and sub circuit to switchably operate based on a second scan signal.

Each of the main circuit and the sub circuit may include a compensation transistor connected to the gate electrode and a drain electrode of the driving transistor, the compensation transistor in each of the main circuit and sub circuit to switchably operate based on the first scan signal.

Each of the main circuit and the sub circuit may include a boost capacitor between a first scan line and the driving transistor gate electrode. Each of the first scan signal and the second scan signal may include an enable pulse, and the enable pulse of the second scan signal may precede the enable pulse of the first scan signal.

Each of the main circuit and the sub circuit may include a first light emission transistor connected between a source electrode of the driving transistor and a first voltage line; and a second light emission transistor connected between the drain electrode of the driving transistor and the organic light emitting diode. The first light emission transistor and the second light emission transistor may be turned on after the data signal is applied.

In accordance with another embodiment, a method for driving a pixel includes setting a first set of wirings in a disconnected state and a second set of wirings in a connected state when a main circuit is in an abnormal state, turning on a switching transistor based on a first scan signal, applying a data signal to a gate electrode of a driving transistor through the turned-on switching transistor, and maintaining a voltage applied to the gate electrode of the driving transistor, based on the data signal, at a storage capacitor, wherein: the first set of wirings is connected to the main circuit, the second set of wirings is connected to a sub circuit, the main circuit in a disconnected state when the second set of wiring is in the connected state and the sub circuit is in a connected state, the first set of wirings is connected to at least one of the switching transistor, the gate electrode of the driving transistor, or the storage capacitor, and the second set of wirings is connected to at least one of the switching transistor, the gate electrode of the driving transistor, or the storage capacitor.

The sub circuit may include a compensation transistor connected to the gate electrode and a drain electrode of the driving transistor, and the driving method may include turning on the second compensation transistor based on the first scan signal, and applying the data signal to the gate electrode of the driving transistor through the turned-on switching transistor and the turned-on compensation transistor.

The sub circuit may include an initialization transistor connected to the gate electrode of the driving transistor and a second voltage source line, and the driving method may include turning on the initialization transistor according to the second scan signal, and applying an initialization voltage to the gate electrode of the driving transistor and the storage capacitor through the turned-on initialization transistor.

Applying the initialization voltage to the gate electrode of the driving transistor and the storage capacitor through the turned-on initialization transistor may be performed before the switching transistor and the compensation transistor are turned on.

The sub circuit may include a first light emission transistor connected between a source electrode of the driving transistor and the first voltage source, and a second light emission transistor connected between the drain electrode of the driving transistor and the organic light emitting diode, and the driving method may include turning on the first light emission transistor based on a light emission control signal, and turning on the second light emission transistor based on a light emission control signal, the organic light emitting diode emitting light based on current flowing through the driving transistor after the data signal is applied to the driving transistor gate electrode.

In accordance with another embodiment, a pixel includes a main circuit, a sub circuit, and an organic light emitting diode, wherein the main circuit includes a switching transistor configured to switchably operate based on a first scan signal, a first driving transistor configured to receive a data voltage through the switching transistor, and a first storage capacitor configured to store the data voltage, and wherein the sub circuit includes a second driving transistor configured to receive a data voltage through the switching transistor and a second storage capacitor configured to store the data voltage, wherein the organic light emitting diode emits light based on current flowing through one of the main circuit or the sub circuit. The data voltage may be stored in one of the first storage capacitor or the second storage capacitor.

In accordance with another embodiment, a method for driving a pixel includes turning on a switching transistor based on a first scan signal, applying a data signal to a gate electrode of one of a first driving transistor or a second driving transistor through the turned-on switching transistor, and maintaining a voltage, applied to the gate electrode of one of the first driving transistor or the second driving transistor according to the data signal, at one of a first storage capacitor or a second storage capacitor, wherein the pixel includes a main circuit, a sub circuit, and an organic light emitting diode, the sub circuit includes the switching transistor to switchably operate based on the first scan signal, the first driving transistor is configured to receive a data voltage through the switching transistor, and the first storage capacitor is configured to store the data voltage, and the sub circuit includes the second driving transistor configured to receive a data voltage through the switching transistor and the second storage capacitor configured to store the data voltage.

In accordance with another embodiment, a pixel includes a main circuit including a first transistor and a sub circuit including a second transistor, wherein the first transistor is connected to a first wiring, the second transistor is connected to a second wiring, the first and second wirings are provided to carry a same signal, the second wiring is in a connected state to carry the signal to the second transistor when the first wiring and the main circuit are in a disconnected state. The signal may be a scan signal, a data signal, or an emission signal. The main circuit and the sub circuit may have a same structure.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2A illustrates an embodiment of a pixel, and FIG. 2B illustrates an embodiment of a switching circuit in or coupled to the pixel in FIG. 2A;

FIG. 3 illustrates an embodiment of a method for driving a pixel;

FIG. 4 illustrates another embodiment of a pixel; and

FIG. 5 illustrates another embodiment of a pixel.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

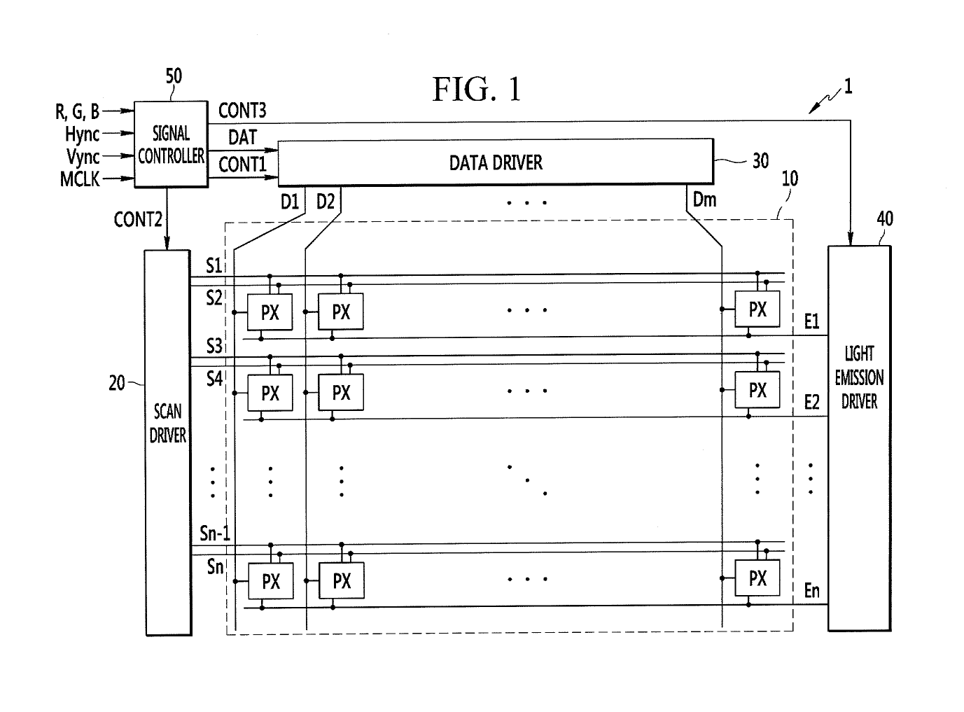

FIG. 1 shows an embodiment of a display device 1 which includes a display unit 10, a scan driver 20, a data driver 30, a light emission driver 40, and a signal controller 50. The display unit 10 includes a plurality of pixels PX connected to scan lines S1-Sn extending in a first direction (e.g., row direction) and a plurality of data lines D1-Dm extending in a second direction (e.g., column direction). Connection structures of the scan lines S1-Sn, the data lines, and voltage supply lines may be different from that shown in FIG. 1.

Each of the pixels PX may include multiple (e.g., three) subpixels emitting light of different colors, e.g., red R, green G, and blue B. Each pixel PX is activated in accordance with a scan signal transmitted through a respective one of the scan lines scan lines S1-Sn. Each subpixel emits light based on a driving current corresponding to a data signal transmitted through a respective one of the data lines D1-Dm, to thereby display an image.

The signal controller 50 receives image signals (e.g., R, G, and B) from an external source and an input control signal for controlling display thereof. The image signals R, G, and B contain luminance information on each pixel PX. The luminance information may include data indicating a gray scale value of a corresponding pixel among a predetermined range of gray scale values, e.g., 1024 (=2¹⁰),) 256 (=2⁸) or 64 (=2⁶) gray scale values. The input control signal includes a vertical synchronization signal Vsync, a horizontal synchronizing signal Hsync, and a main clock MCLK.

The signal controller 50 processes the image signals R, G, and B based on an operation condition of the display unit 10 and the input control signal, to generate an image data for input into the data driver 30. The signal controller 50 also generates a data control signal CONT1, a scan control signal CONT2, a light emission control signal line CONT3. The signal controller 50 transmits the scan control signal CONT2 to the scan driver 20, and transmits the data control signal CONT1 and image data signals DAT to the data driver 30.

The scan driver 20 supplies a plurality of scan signals S[1]-S[n] to respective ones of the scan lines S1-Sn according to the scan control signal CONT2.

The data driver 30 generates a plurality of data signals (e.g., data voltages) according to the image data signals DAT input based on the data control signal CONT1. The data signals are supplied to respective ones of the data lines D1-Dm. For example, the data driver 30 is synchronized at a time when the scan signal of a gate-on voltage corresponding to each frame is supplied, and transmits a plurality of data signals for controlling an emission degree of each of the pixels PX through the data lines D1-Dm. A gate-on voltage corresponds to a level for turning on a switching transistor in each pixel PX.

The light emission driver 40 supplies a plurality of light emission signals EM[1]-EM[n]) to respective ones of a plurality of light emission control lines E1-En.

Each pixel PX is connected to two scan lines among the scan lines S1-Sn, a light emission control line among the emission control lines E1-En, and a data line among the data lines D1-Dm. Data voltages corresponding to the image data signal DAT are transmitted to the pixels PX through respective data lines D1-Dm. A scan signal is transmitted to each pixel PX through a respective scan line. A light emission signal for controlling light emission of an organic light emitting diode (OLED) of each pixel PX is transmitted through a respective light emission control line.

The scan driver 20, the data driver 30, the light emission driver 40, and the signal controller 50 may be electrically connected to the display unit 10. For example, each of the drivers 20, 30, and 40 and the signal controller 50 may be included in one or more integrated chip mounted on a flexible printed circuit or a film attached and electrically connected to the display unit 10. Alternatively, the scan driver 20, the data driver 30, the light emission driver 40, and the signal controller 50 may be directly mounted on a glass substrate of the display unit 10, and/or may be formed on the same layers as those of the scan line, the data line, the voltage supply line, and the thin film transistor.

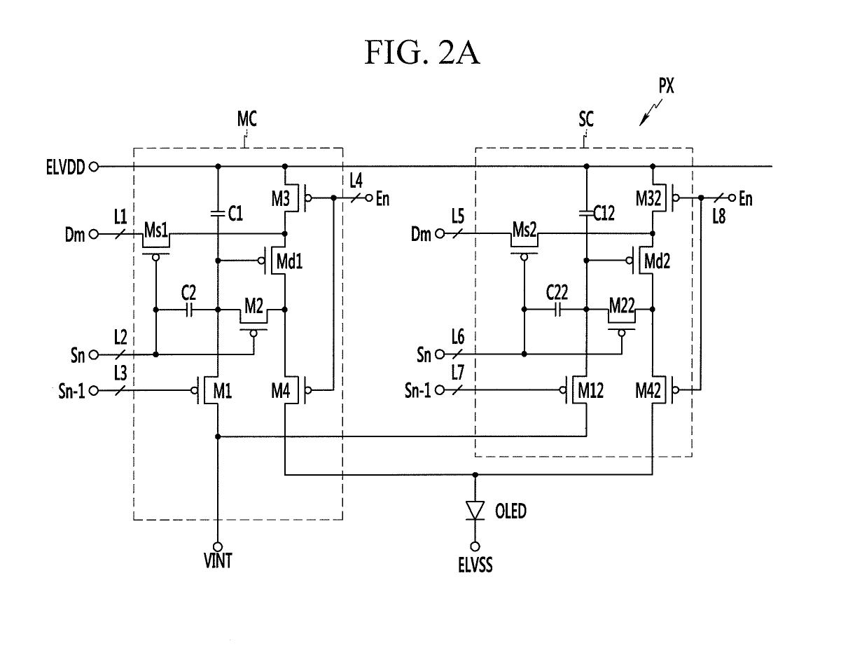

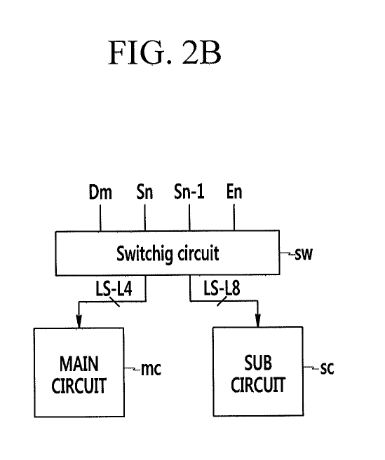

FIG. 2A illustrates an embodiment of a pixel PX, which, for example, may be connected to an (n−1)^{th} scan line S(n−1), a n^{th} scan line Sn, a n^{th} light emission control signal line En, and a m^{th} data line Dm. The other pixels PX may have a similar structure.

As shown in FIG. 2A, the pixel PX includes a main circuit MC, a sub circuit SC, an OLED, and wirings L1-L8. The main circuit MC and the sub circuit SC may perform the same functions. In other embodiments, the main circuit MC and the sub circuit SC may perform at least one common function and at least one different function.

During normal operation of the main circuit MC, the scan line, the light emission control signal line, and the data line corresponding to the wirings L1-L4 are in a connected state and the wirings L5 to L8 are in a disconnected state. When the main circuit MC is not operating normally, the wirings L1-L4 are in a disconnected state, and the scan line, the light emission control signal line, and the data line corresponding to the wirings L1-L4 are in a disconnected state, to thereby allow the sub circuit SC to replace the main circuit MC.

The main circuit MC includes a switching transistor Ms1, a driving transistor Md1, a compensation transistor M2, an initialization transistor M1, light emission transistors M3 and M4, a storage capacitor C1, a boost capacitor C2, and the wirings L1-L4.

A driving voltage for performing light emission of the OLED in the pixel PX is applied to a first voltage supply line ELVDD. In one embodiment, the voltage values of the driving voltage applied to the first voltage supply line ELVDD may be different, e.g., may be voltage values preset by the signal controller 50. Although the transistors in FIG. 2A are illustrated as p-channel metal oxide semiconductor (PMOS) transistors, NMOS or a combination of PMOS and NMOS transistors may be used in other embodiments.

The switching transistor Ms1 may include a gate electrode connected to the scan line Sn, a source electrode connected to the data line Dm, and a drain electrode connected to a source electrode of the driving transistor Md1. When the switching transistor Ms1 is turned on by the scan signal S[n], the data signal D[m] applied to the data line Dm is transmitted to the source electrode of the driving transistor Md1.

The driving transistor Md1 may include the source electrode to which the data voltage is transferred during a turn-on period of the switching transistor Ms1, a gate electrode connected to a first end of the storage capacitor C1, and a drain electrode connected to a source of the light emission transistor M4.

The first end of the storage capacitor C1 is connected to a gate electrode of the driving transistor Md1, and a second end is connected to the first voltage supply line ELVDD to which the driving voltage is applied.

The initialization transistor M1 may include gate electrode connected to the scan line S(n−1), a drain electrode connected to an initialization voltage supply line VINT to which an initialization voltage, and a source electrode connected to the gate electrode of the driving transistor Md1

A first end of the boost capacitor C2 is connected to the scan line Sn, and a second end is connected to the source electrode of the initialization transistor M1.

The compensation transistor M2 may include a gate electrode connected to the scan line, a drain electrode connected to the gate electrode of the driving transistor Md1, and a source electrode connected to the drain electrode of the driving transistor Md1. The compensation transistor M2 may be turned on by the scan signal, applied to the scan line Sn, to facilitate a diode-connection of the driving transistor Md1.

The light emission transistor M3 may include a gate electrode connected to the light emission control signal line En, a source electrode connected to the first voltage supply line ELVDD to which the driving voltage is applied, and a drain electrode connected to the source of the driving transistor Md1.

The light emission transistor M4 may include a gate electrode connected to the light emission control signal line En, a source electrode connected to the drain electrode of the driving transistor Md1, and a drain electrode connected to an anode electrode of the OLED.

The sub circuit SC may include a switching transistor Ms2, a driving transistor Md2, a compensation transistor M12, an initialization transistor M22, light emission transistors M32 and M42, and a storage capacitor C12, and a boost capacitor C22.

The function of the switching transistor Ms2, the driving transistor Md2, the storage capacitor C12, the compensation transistor M12, the boost capacitor C22, the initialization transistor M22, the light emission transistor M32, and the light emission transistor M42 may be the same as in the main circuit MC. Also, the switching transistor Ms2, the driving transistor Md2, the storage capacitor C12, the compensation transistor M12, the boost capacitor C22, the initialization transistor M22, the light emission transistor M32, and the light emission transistor M42 may be in a connected state and a disconnected state.

The wiring L1 may be between the data line Dm and the source electrode of the switching transistor Ms1, in order to connect the data line Dm with the source electrode of the switching transistor Ms1.

The wiring L2 may be between the scan line Sn and the gate electrodes of the switching transistor Ms1 and the compensation transistor M2, in order to connect the scan line with the gate electrodes of the switching transistor Ms1 and the compensation transistor M2.

The wiring L3 may be between the scan line S(n−1) and the gate electrode of the initialization transistor M1, in order to connect the scan line S(n−1) with the gate electrode of the initialization transistor M1.

The wiring L4 may be between the light emission control signal line En and the gate electrodes of the light emission transistors M3 and M4, in order to connect the light emission control signal line En with the gate electrodes of the light emission transistors M3 and M4.

The wirings L1 to L4 may be in the connected state when the main circuit MC is operating normally, and may be in the disconnected state when the main circuit MC is operating abnormally.

The wiring L5 may be between the data line Dm and the source electrode of the switching transistor Ms2, in order to connect the data line Dm with the source electrode of the switching transistor Ms2 when the wiring L1 is in the disconnected state.

The wiring L6 may be between the scan line Sn and the gate electrodes of the switching transistor Ms2 and the compensation transistor M22, in order to connect the scan line Sn with the gate electrodes of the switching transistor Ms2 and the compensation transistor M22 when the wiring L2 is in the disconnected state.

The wiring L7 may be located the scan line S(n−1) and the gate electrode of the initialization transistor M12, in order to connect the scan line S(n−1) with the gate electrode of the initialization transistor M12 when the wiring L3 is in the disconnected state.

The wiring L8 may be between the light emission control signal line En and the gate electrodes of the light emission transistors M32 and M42, in order to connect the light emission control signal line En with the gate electrodes of the light emission transistors M32 and M42 when the wiring L4 is in the disconnected state.

The wirings L5-L8 are not in the connected state when the main circuit MC is operating normally, and may be in the connected state to enable the sub circuit SC to replace the main circuit MC when the wiring L1 to L4 are in the disconnected state by an error of the main circuit MC.

The operational status of the main circuit MC may be determined in a number of ways. For example, the operational status of the main circuit MC may be determined by a quality control test performed by the manufacturer. When the main circuit MC is determined to be operating abnormally, the main circuit MC may be placed in the disconnected state and the sub circuit SC may be placed in the connected state. This may be accomplished, for example, by cutting lines L1-L4 using a cutting tool (e.g., a laser) and by connecting lines L5-L8, for example, by depositing conductive material to connect wirings L5-L8 to the sub circuit SC.

The OLED may include an anode electrode connected to the drain electrodes of the light emission transistors M4 and M42, and a cathode electrode connected to a second voltage supply line ELVSS to which a voltage is supplied. When the light emission transistors M3 and M32 (or M4 and M42) are turned on by a light emission signal transferred through the light emission control signal line En, the OLED emits light according to a current flowing through the driving transistor Md1 (or Md2) to display a corresponding image.

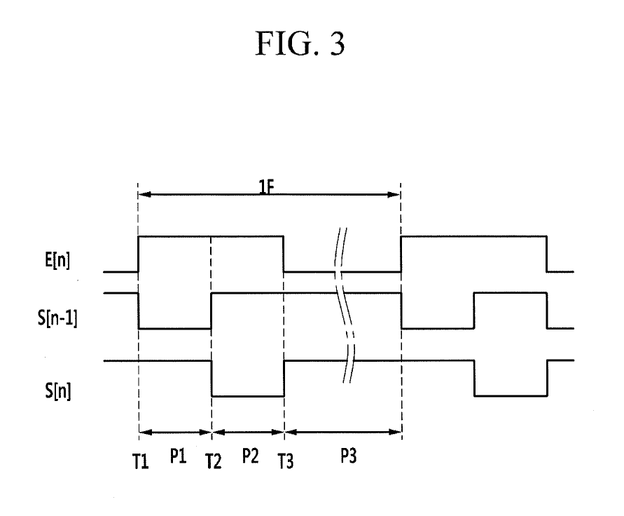

FIG. 3 illustrates an embodiment of a method for driving a pixel, which, for example, may be the pixel PX in FIG. 2A. In this figure, operation of the main circuit MC may be shown based on a timing diagram that includes signals for a predetermined period including one frame period 1F.

The signals include a scan signal S[n−1], a scan signal S[n], and a light emission signal E[n]. Each of the scan signals S[n−1] and S[n] includes an enable pulse, and the enable pulses for the scan lines are sequentially generated. In this embodiment, because the transistors in the main circuit MC are a p-channel type transistors, an enable level corresponds to a low level.

Referring to FIG. 3, the light emission signal En is applied to the light emission signal line En at a time point T1 of an initialization period P1. As a result, the light emission transistors M3 and M4 are turned off to block current from flowing through the driving transistor Md1.

At the time point T1 of the initialization period P1, the scan signal S[n−1] of a low level is applied to the scan line S(n−1) to turn on the initialization transistor M1 during the initialization period P1. When the initialization transistor M1 is turned on, an initialization voltage VINT is applied to the gate electrode of the driving transistor Md1 to initialize the driving transistor Md1, and the storage capacitor C1 is initialized by the (ELVDD-VINT) voltage.

At a time point T2 of a scan period P2, the scan signal of a low level S[n] is applied to the scan line Sn. As a result, the switching transistor Ms1 and compensation transistor M2 are turned on during the scan period. When the compensation transistor M2 is turned on, the driving transistor Md1 is placed in a diode-connected state, e.g., the gate electrode and the drain electrode of the driving transistor Md1 are connected to each other by the turned-on compensation transistor M2. Accordingly, the voltage between the gate electrode and the source electrode of the driving transistor Md1 becomes a threshold voltage of the driving transistor Md1.

The data signal D[k] is applied from the data line Dm to the source electrode of the driving transistor Md1. When the voltage of the data signal D[k] is Vdata and the threshold voltage of the driving transistor Md1 is Vth (negative voltage), the gate voltage of the driving transistor Md1 becomes Vdata+Vth. The voltage applied to the gate electrode of the driving transistor Md1 is maintained by the storage capacitor C1.

At a time point T3 of a light emission period P3, when the scan signal of a high level S[n] is applied to the scan line Sn, a voltage VR of the scan signal Sn is divided based on the capacitances of the storage capacitor C1 and the boost capacitor C2. For example, when the capacitance of the storage capacitor C1 is c1 and the capacitance of the boost capacitor C2 is c2, the gate voltage of the driving transistor Md1 is increased by Δ(c1/(c1+c2))VR).

The light emission signal of a low level E[n] is applied to the light emission control line En. During the light emission period P3, the light emission transistors M3 and M4 are turned on. The gate-source voltage of the driving transistor Md1 may be determined by Equation 1. During the light emission period P3, when the driving transistor Md1 is turned on, the OLED emits light based on the current flowing through the driving transistor Md1.

Vgs=(Vdata+Vth+ΔV)−ELVDD (1)

In Equation 1, Vgs is the gate-source voltage of the driving transistor Md1, Vth is the threshold voltage of the driving transistor Md1, and Vdata is the data voltage transferred from the data line Dm.

The current flowing in the OELD through the driving transistor Md1, and a value of the current flowing through the OLED may be determined by Equation 2.

$$\begin{matrix}IOLED = β / 2 {( Vgs - Vth )}^{2} \\ = β / 2 {( ( Vdata + Vth + Δ V - ELVDD ) - Vth )}^{2} \\ = β / 2 {( Vdata + Δ V - ELVDD )}^{2}\end{matrix} \qquad ( 2 )$$

In Equation 2, IOLED is the current flowing through the OLED and β is a predetermined constant value.

In operation, deviation may be generated in the threshold voltage Vth of a thin film transistor per pixel PX based on non-uniformity of the manufacturing process. As a result, the amount of current supplied to the OLED may changed, which may change or otherwise adversely affect light emission luminance. However, in accordance with one embodiment, as recognized by the Equation 2, even when the threshold voltage of the driving transistor Md1 varies from each other in different pixels, adverse effects of the threshold voltages may be excluded. As a result, it is possible to supply a constant current to the OLEDs in the pixels.

In FIG. 3, the enable pulses of the scan signals S[1]-S[n] have the same width. In other embodiments, the scan signals S[1]-S[n] may have different widths.

When the main circuit MC is operating normally, the wirings L1-L4 are in a connected state as previously described. Operation of the sub circuit SC when wirings L5-L8 are in a connected state (e.g., when since the main circuit MC is operating abnormally because of a defect or malfunction) may be substantially the same as the main circuit MC.

In the pixel PX in FIG. 2B, a switching circuit may be included to control the connected and disconnected states of wirings L1-L4 and wirings L5-L8. For example, when main circuit MC is operating normally, the switching circuit may assume a first switching state to place wirings L1-L4 in a connected state, e.g., may allow the data signal, the scan signals, and emission signal to flow through respective wirings L1-L4 to transistors Ms1, M1, M2, and M3 in the main circuit MC. The wirings 5-L8 may be in a disconnected state in the first switching state.

When main circuit MC is operating abnormally, the switching circuit may assume a second switching state to place wirings L5-L8 in a connected state, e.g., may allow the data signal, the scan signals, and the emission signal to flow through respective wirings L5-L8 to transistors Ms2, M12, M22, and M32 in sub circuit SC. The wirings L1-L4 may be in a disconnected state in the second switching state. The switching circuit may be controlled to assume the first switching state or the second switching state based on a control signal, for example, from signal controller 50.

FIG. 2B illustrates an example of the switching circuit SW connected to the main circuit MC and sub circuit SC. When the main circuit MC is operating normally, the switching circuit SW receive a control signal having a first value to cause the switching circuit to assume the first switching state. When the main circuit MC is operating abnormally, the switching circuit SW may receive a control signal having a second value to cause the switching circuit to assume the second switching state.

In an alternative embodiment, the switching circuit may have a default state corresponding to the first switching state and may assume the second switching state when a control signal is received. The switching circuit may be locally located in each pixel in the display panel 10. In an alternative embodiment, the switching circuit may be replaced with a fuse circuit which receives a control signal from a controller (e.g., signal controller 50) to disconnect wirings L1-L4. The switching circuit SW or fuse circuit may be considered as a selector.

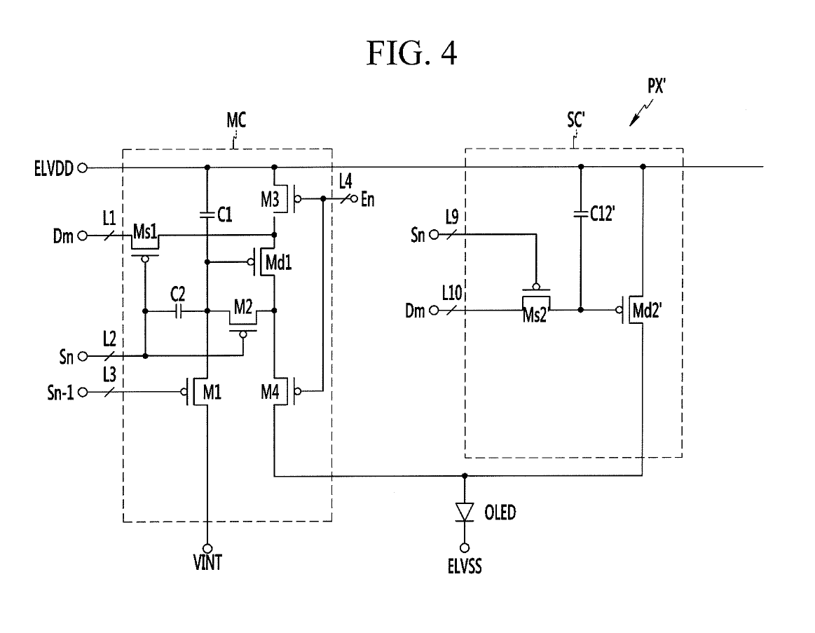

FIG. 4 illustrates another embodiment of a pixel PX′ which includes scan lines S(n−1) and Sn, a data line Dm, a light emission control signal line En, a main circuit MC connected to an anode electrode of an OLED, a sub circuit SC′, the OLED, and wirings L1-L4, L9, and L10. The wirings L1 to L4 may be the same as in FIG. 2.

The sub circuit SC′ may include a switching transistor Ms2′, a driving transistor Md2′, and a storage capacitor C12. The switching transistor Ms2′, the driving transistor Md2′, and the storage capacitor C12 may be the same as the switching transistor Ms2, the driving transistor Md2, and the storage transistor C12 as in FIG. 2.

The wiring L9 may be between the scan line Sn and a gate electrode of the switching transistor Ms2′, in order to connect the scan line Sn with the gate electrode of the switching transistor Ms2′ when the wiring L1 is in the disconnected state.

The wiring L10 may be between the data line Dm and a source electrode of the switching transistor Ms2′, in order to connect the data line Dm with the source electrode of the switching transistor Ms2′ when the wiring L10 is in the disconnected state.

The wirings L9 and L10 are not in the connected state when the main circuit MC is operating normally. However, when the wirings L1-L4 are in the disconnected state, the wiring L9 connects the scan line Sn with the gate electrode of the switching transistor Ms2′, and the wiring L10 connects the data line Dm with the source electrode of the switching transistor Ms2′. As a result, the switching transistor Ms2, the driving transistor Md2, and the storage transistor C12 of the sub circuit SC′ may respectively replace the switching transistor MS1, the driving transistor Md1, and the storage capacitor C1 of the main circuit SC.

The pixel PX′ in FIG. 4 may include or be coupled to a switching circuit similar to the one in FIG. 2B or a fuse circuit to control the connected and disconnected states of wirings L1 and L2 and the connected and disconnected states of wirings L9 and L10.

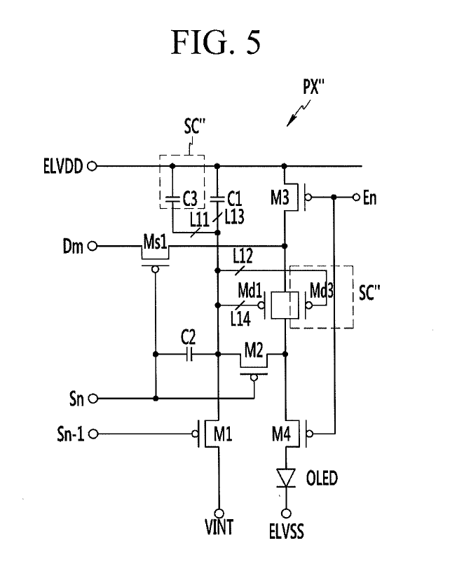

FIG. 5 illustrates another embodiment of a pixel PX″ which include a switching transistor Ms1, a driving transistor Md1, a compensation transistor M2, an initialization transistor M1, light emission transistors M3 and M4, a storage capacitor C1, a boost capacitor C2, wirings L11-L14, and sub circuit SC″. The switching transistor Ms1, the transistor Md1, the compensation transistor M2, the initialization transistor M1, the light emission transistors M3 and M4, the storage capacitor C1, the boost capacitor C2 may be the same as in FIG. 2.

The circuit SC″ may include a driving transistor Md3 and a storage capacitor C3. When the driving transistor Md1 or the storage capacitor C1 is defective, the driving transistor Md3 or the storage capacitor C3 of the sub circuit SC″ may replace the driving transistor Md1 or the storage capacitor C1 of the PX′.

The driving transistor Md3 may include a source electrode to which a data voltage is transferred while the switching transistor Ms1 is turned on, a gate electrode connected to a first end of the storage capacitor C1, and a drain electrode connected to a source electrode of the light emission transistor M4.

A first end of the storage capacitor C3 is connected to a gate electrode of the driving transistor Md1, and a second end is connected to the first voltage supply line ELVDD to which the driving voltage is applied.

The wiring L11 may be between the first end of the storage capacitor C3 and the gate electrode of the driving transistor Md1, in order to connect the first end of the storage capacitor C3 with the gate electrode of the driving transistor Md1 when the wiring L13 is in the disconnected state.

The wiring L12 may be between the gate electrode of the driving transistor Md3 and the first end of the storage capacitor C1, in order to connect the gate electrode of the driving transistor Md3 with the first end of the storage capacitor C1 when the wiring L14 is in the disconnected state.

The wiring L13 may be between the first end of the storage capacitor C1 and the gate electrode of the driving transistor Md1, in order to correct the first end of the storage capacitor C1 with the gate electrode of the driving transistor Md.

The wiring L14 may be between the gate electrode of the driving transistor Md1 and the first end of the storage capacitor Md1, in order to correct the gate electrode of the driving transistor Md1 with the first end of the storage capacitor Md1.

When the driving transistor Md1 is operating normally, the wiring L14 is in the connected state and the wiring L12 is in the disconnected state, which may facilitate operation of the driving transistor Md1. When the driving transistor Md1 is operating abnormally, the wiring L12 is in the connection state and the wiring L14 is in the disconnected state, which may facilitate operation of the driving transistor Md3.

When the storage capacitor C1 is operating normally operated, the wiring L13 is in the connected state and the wiring L11 is in the disconnected state, which may facilitate operation of the storage capacitor C1. When the storage capacitor C1 is operating abnormally, the wiring L11 is in the connected state and the wiring L13 is in the disconnected state, which may facilitate operation of the storage capacitor C3. The function of the driving transistor Md3 or the storage capacitor C3 may be the same as described in FIG. 2.

The pixel PX″ in FIG. 5 may include or be coupled to a switching circuit similar to the one in FIG. 2B, or a fuse circuit, to control the connected and disconnected states of wirings L11 and L12 and the connected and disconnected states of wirings L13 and L14.

By way of summation and review, When a defect is generated in a pixel circuit during a manufacturing process, a repair process may be performed by cutting the defective portion of the circuit and remanufacturing it. However, this technique may result in a low success rate of regeneration and a long tact time.

In accordance with one or more of the aforementioned embodiments, each pixel in a display device includes a main circuit and a sub circuit. When the main circuit is determined to be in a defective state after manufacture (e.g., by performing a quality control test), the main circuit is placed in a disconnected state and the sub circuit is placed in a connected state. As a result, the defective pixel operates normally and remanufacturing does not have to be performed.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A pixel, comprising:
a main circuit;
a sub circuit; and
an organic light emitting diode,
wherein each of the main circuit and the sub circuit includes a switching transistor to switchably operate based on a first scan signal, a driving transistor to receive a data voltage through the switching transistor, and a storage capacitor to store the data voltage, and wherein the organic light emitting diode emits light based on current flowing through one of the main circuit or the sub circuit.

2. The pixel as claimed in claim 1, wherein each of the main circuit and the sub circuit includes:
an initialization transistor connected to a gate electrode of the driving transistor and a second voltage source line, the initialization transistor in each of the main circuit and sub circuit to switchably operate based on a second scan signal.

3. The pixel as claimed in claim 2, wherein each of the main circuit and the sub circuit includes:
a compensation transistor connected to the gate electrode and a drain electrode of the driving transistor, the compensation transistor in each of the main circuit and sub circuit to switchably operate based on the first scan signal.

4. The pixel as claimed in claim 3, wherein each of the main circuit and the sub circuit includes a boost capacitor between a first scan line and the driving transistor gate electrode.

5. The pixel as claimed in claim 4, wherein:
each of the first scan signal and the second scan signal includes an enable pulse, and
the enable pulse of the second scan signal precedes the enable pulse of the first scan signal.

6. The pixel as claimed in claim 5, wherein each of the main circuit and the sub circuit includes:
a first light emission transistor connected between a source electrode of the driving transistor and a first voltage line; and
a second light emission transistor connected between the drain electrode of the driving transistor and the organic light emitting diode.

7. The pixel as claimed in claim 6, wherein the first light emission transistor and the second light emission transistor are turned on after the data voltage is applied.

8. A method for driving a pixel, the method comprising:
setting a first set of wirings in a disconnected state and a second set of wirings in a connected state when a main circuit is in an abnormal state;
turning on a switching transistor based on a first scan signal;
applying a data signal to a gate electrode of a driving transistor through the turned-on switching transistor; and
maintaining a voltage applied to the gate electrode of the driving transistor, based on the data signal, at a storage capacitor, wherein:
the first set of wirings is connected to the main circuit,
the second set of wirings is connected to a sub circuit,
the main circuit in a disconnected state when the second set of wiring is in the connected state and the sub circuit is in a connected state,
the first set of wirings is connected to at least one of the switching transistor, the gate electrode of the driving transistor, or the storage capacitor, and
the second set of wirings is connected to at least one of the switching transistor, the gate electrode of the driving transistor, or the storage capacitor.

9. The method as claimed in claim 8, wherein:
the sub circuit includes a compensation transistor connected to the gate electrode and a drain electrode of the driving transistor, and
the driving method includes turning on the compensation transistor based on the first scan signal, and applying the data signal to the gate electrode of the driving transistor through the turned-on switching transistor and the turned-on compensation transistor.

10. The method as claimed in claim 9, wherein:
the sub circuit includes an initialization transistor connected to the gate electrode of the driving transistor and a second voltage source line, and
the driving method includes turning on the initialization transistor according to a second scan signal, and applying an initialization voltage to the gate electrode of the driving transistor and the storage capacitor through the turned-on initialization transistor.

11. The method as claimed in claim 10, wherein applying the initialization voltage to the gate electrode of the driving transistor and the storage capacitor through the turned-on initialization transistor is performed before the switching transistor and the compensation transistor are turned on.

12. The method as claimed in claim 11, wherein:
the sub circuit includes a first light emission transistor connected between a source electrode of the driving transistor and a first voltage source, and a second light emission transistor connected between the drain electrode of the driving transistor and an organic light emitting diode in the pixel, and
the driving method includes turning on the first light emission transistor based on a light emission control signal, and turning on the second light emission transistor based on a light emission control signal, the organic light emitting diode emitting light based on current flowing through the driving transistor after the data signal is applied to the driving transistor gate electrode.

13. A pixel, comprising:
a main circuit;
a sub circuit; and
an organic light emitting diode,
wherein the main circuit includes a switching transistor to switchably operate based on a first scan signal, a first driving transistor to receive a data voltage through the switching transistor, and a first storage capacitor to store the data voltage, and
wherein the sub circuit includes a second driving transistor configured to receive a data voltage through the switching transistor and a second storage capacitor configured to store the data voltage,
wherein the organic light emitting diode emits light based on current flowing through one of the main circuit or the sub circuit.

14. The pixel as claimed in claim 13, wherein the data voltage is stored in one of the first storage capacitor or the second storage capacitor.

15. A method for driving a pixel, the method comprising:
turning on a switching transistor based on a first scan signal;
applying a data signal to a gate electrode of one of a first driving transistor or a second driving transistor through the turned-on switching transistor; and
maintaining a voltage, applied to the gate electrode of one of the first driving transistor or the second driving transistor according to the data signal, at one of a first storage capacitor or a second storage capacitor, wherein:
the pixel includes a main circuit, a sub circuit, and an organic light emitting diode,
the sub circuit includes the switching transistor to switchably operate based on the first scan signal,
the first driving transistor is to receive a data voltage through the switching transistor, and
the first storage capacitor is to store the data voltage, and
the sub circuit includes the second driving transistor to receive a data voltage through the switching transistor and the second storage capacitor configured to store the data voltage.

16. A pixel, comprising:
a main circuit including a first transistor; and
a sub circuit including a second transistor, wherein:
the first transistor is connected to a first wiring,
the second transistor is connected to a second wiring,
the first and second wirings are provided to carry a same signal,
the second wiring is in a connected state to carry the signal to the second transistor when the first wiring and the main circuit are in a disconnected state.

17. The pixel as claimed in claim 16, wherein the signal is a scan signal.

18. The pixel as claimed in claim 16, wherein the signal is a data signal.

19. The pixel as claimed in claim 16, the signal is an emission signal.

20. The pixel as claimed in claim 16, wherein the main circuit and the sub circuit have a same structure.
